(19) United States
(12) Patent Application Publication
(10) Pub. No.: US 2014/0008143 A1
(43) Pub. Date: Jan. 9, 2014

(54) ENCLOSING DEVICE AND A MEDICAL IMAGING DEVICE HAVING THE ENCLOSING DEVICE

(71) Applicant: Michael Eberler, Postbauer-Heng (DE)

(72) Inventor: Michael Eberler, Postbauer-Heng (DE)

(21) Appl. No.: 13/933,422

(22) Filed: Jul. 2, 2013

(30) Foreign Application Priority Data
Jul. 5, 2012 (DE) 102012211715.6

(51) Int. Cl. F16F 7/00

(52) U.S. Cl. CPC F16F 7/00
USPC 181/202

(57) ABSTRACT

An enclosing device, in particular for a magnetic resonance device, includes at least one first enclosing shell and at least one second enclosing shell. The enclosing device has a double-walled enclosing shell unit which comprises the first enclosing shell and the second enclosing shell.

### CROSS REFERENCE TO RELATED APPLICATIONS

The present application claims priority to German Patent Office application No. 10 2012 211715.6 DE filed Jul. 5, 2012, the entire content of which is hereby incorporated herein by reference.

### FIELD OF INVENTION

The present invention relates to an enclosing device, in particular for a medical imaging device, comprising at least one first enclosing shell and at least one second enclosing shell.

### BACKGROUND OF INVENTION

When in operation, magnetic resonance devices generate high levels of operating noise which can have an unpleasant effect on a patient contained in a receiving area of the magnetic resonance device for the purpose of an examination. Said high operating noise levels are generated inside a magnet unit of the magnetic resonance device as a result of an interaction of a gradient unit with a magnet. Sound is transmitted inside the magnetic resonance device in this case as a result of airborne sound excitation as well as by way of an input of structure-borne sound. In this manner the high operating noise levels are transmitted onto a housing unit of the magnetic resonance device and from said housing unit are radiated into a space surrounding the magnetic resonance device.

Enclosing devices for magnetic resonance devices perform several functions, one such being noise attenuation. For this purpose enclosing devices having a very high mass have advantageous noise attenuating properties and/or advantageous properties in terms of damping of vibrations. However, heavy enclosing devices are disadvantageous with regard to assembly and/or installation, such as in a service situation and/or for maintenance activities. For assembly and/or installation convenience, the enclosing devices should be embodied in the most lightweight form possible, though in most cases enclosing devices of said type have poor noise attenuating properties.

### SUMMARY OF INVENTION

The object underlying the present invention is in particular to provide an enclosing device for a medical imaging device, in particular a magnetic resonance device, which is embodied as flexible in terms of noise attenuation and a weight property. The object is achieved by means of the features of the independent claims. Advantageous embodiments are described in the dependent claims.

The invention relates to an enclosing device, in particular for a magnetic resonance device, having at least one first enclosing shell and at least one second enclosing shell.

It is proposed that the enclosing device have a double-walled enclosing shell unit which comprises the at least one first enclosing shell and the at least one second enclosing shell. In this way a particularly flexible enclosing device can be achieved in terms of noise attenuation and/or damping of vibrations, in particular with regard to absorption of sound waves. Noise attenuating properties and/or damping properties for damping vibrations and/or sound absorption properties of the enclosing device can be influenced in particular by a choice of material for the first enclosing shell and/or a choice of material for the second enclosing shell and/or an arrangement of the two enclosing shells with respect to each other and/or other measures in relation to noise attenuation and/or noise reduction and damping of vibrations that are deemed beneficial by the person skilled in the art. Particularly advantageously, however, additional noise absorbing elements can be arranged in this case between the two enclosing shells, said elements preferably not being introduced until after assembly and installation of the enclosing device in order in that way to allow easy assembly and installation with a lightweight enclosing device. Furthermore, a selection of the noise absorbing elements can be adapted to suit an anticipated radiation of noise from the medical imaging device, in particular the magnetic resonance device.

It is additionally proposed that the double-walled enclosing shell unit have at least one receiving chamber which is arranged between the at least one first enclosing shell and the at least one second enclosing shell. The receiving chamber enables a noise attenuating property and/or a damping property for damping and/or reducing vibrations of the enclosing device to be improved further in that further noise attenuating elements and/or vibration damping elements, in particular sound absorbing elements, can additionally be arranged inside the receiving chamber.

Particularly advantageous noise attenuation and/or vibration damping can be achieved by means of the enclosing shell device if the receiving chamber is embodied as leak-tight in respect of an exchange of gas or an exchange of liquid. By this means a noise attenuating property that has been set and/or a vibration damping property that has been set, for example by filling the receiving chamber with a specific gas and/or a specific liquid, can advantageously be maintained over a relatively long period of time. Moreover, maintenance work and maintenance costs, such as topping up with a filler for example, in particular a liquid and/or a gas and/or a gel and/or a granulate, etc., can be reduced in the process.

It is furthermore proposed that the double-walled enclosing shell unit have a filler element that is arranged inside the receiving chamber, thereby enabling a noise attenuating property and/or a vibration damping property to be set on the enclosing device as a function of a material and/or of material properties of the filler element. Preferably the filler element comprises a sound absorbing element for absorbing in particular structure-borne sound waves. In this case the filler element can be chosen as a function of the medical imaging device, in particular the magnetic resonance device, and/or of safety regulations at the installation site of the medical imaging device. In this case the filler element and/or the sound absorption element can be a liquid, such as water and/or an oil, for example, and/or other liquids having an advantageous noise attenuating property and/or vibration damping property that are deemed beneficial by the person skilled in the art, and/or a gel and/or a granulate and/or a gas.

In another embodiment of the invention it is proposed that the double-walled enclosing shell unit have at least one inlet opening having a valve element. In this case the enclosing shell device, in particular the double-walled enclosing shell unit, can be embodied in particularly lightweight form, in particular without filler element, for example in order to facilitate the transportation and/or assembly and installation of the medical imaging device, in particular the magnetic resonance device, and the receiving chamber can be filled only after arrival at the installation site, in particular after the double-walled enclosing shell unit has been mounted on the medical imaging device, in particular the magnetic resonance device. Furthermore, this enables a particularly flexible enclosing device to be provided for medical imaging devices, in particular magnetic resonance devices, which enclosing device is embodied in particularly lightweight form in order to facilitate transportation and/or assembly and installation of the enclosing device and nonetheless has an advantageous noise attenuating property and/or vibration damping property, in particular after being filled with a filler element. Furthermore, the enclosing device, in particular the double-walled enclosing shell unit, can be particularly easily dismantled even during maintenance work in that the filler element can flow out of the receiving chamber by way of the inlet opening and the valve element, thus making a lightweight, double-walled enclosing shell unit available once more. Moreover, it is also conceivable that by this means the filler elements inside the receiving chamber of the double-walled enclosing shell unit can be interchanged as a function of a desired noise attenuating property and/or vibration damping property of the double-walled enclosing shell unit.

It is furthermore proposed that the double-walled enclosing shell unit have an outlet opening having a valve element. This enables the receiving chamber to be filled particularly easily in that when the receiving chamber is being filled with the filler, air contained within the receiving chamber for example is able to escape through the outlet opening and the valve element. Furthermore, when the receiving chamber is being emptied, the outlet opening can also be provided to allow air to flow into the receiving chamber so that in this way an undesirable negative pressure inside the receiving chamber can be prevented. In this case the outlet opening is preferably arranged on the receiving chamber in such a way that by means of the outlet opening having the valve element the filler element will also flow through the outlet opening only when the receiving chamber has been completely filled with the filler element. If, however, the receiving chamber is only partly filled with the filler element, air in particular will flow to the outside through the outlet opening and the valve element while the receiving chamber is being filled.

The valve element of the inlet opening and/or the valve element of the outlet opening can have a screw element and/or other valve elements that are deemed beneficial by the person skilled in the art.

Inside the double-walled enclosing shell unit the at least one first enclosing shell is particularly advantageously arranged at a distance of at least 5 mm from the at least one second enclosing shell. Preferably, however, the distance between the at least one first enclosing shell and the at least one second enclosing shell inside the double-walled enclosing shell unit is at least 10 mm. Furthermore, a maximum distance between the at least one first enclosing shell and the at least one second enclosing shell inside the double-walled enclosing shell unit is 40 mm, preferably no more than 35 mm and particularly preferably no more than 30 mm. Particularly advantageously, however, the distance between the at least one first enclosing shell and the at least one second enclosing shell inside the double-walled enclosing shell unit is embodied as between 10 mm and 20 mm.

In this case, for example, the individual enclosing shells are at least partially formed from a deep-drawn thermoplastic, the individual enclosing shells being pressed together to form the double-walled enclosing shell in a pressure forming process. By this means the double-walled enclosing shell can be implemented in a particularly lightweight form and in addition possess sufficiently high stability. In this case the distance between the at least one first enclosing shell and the at least one second enclosing shell can preferably be adjusted to match the medical imaging device that is to be enclosed, in particular the magnetic resonance device, in terms of an anticipated emission of noise, in which case the distance can additionally be chosen with regard to realizing a maximally compact and rigid enclosing shell unit.

In another embodiment of the invention it is proposed that the double-walled enclosing shell unit have at least one spacing element which is arranged between the at least one first enclosing shell and the at least one second enclosing shell. A constant distance can advantageously be achieved between the two enclosing shells, even with a large-scale, double-walled enclosing shell unit. Furthermore, in this case the distance between the at least one first enclosing shell and the at least one second enclosing shell can be kept constant irrespective of a property, in particular a density, of the filler element arranged inside the receiving chamber. In this way a consistent noise attenuating property and/or vibration damping property can be maintained, in particular along a surface of an enclosing shell.

Furthermore, if the at least one spacing element is fixedly connected to the at least one first enclosing shell and/or to the at least one second enclosing shell, a fixed and/or constant distance can be achieved between the at least one first enclosing shell and the at least one second enclosing shell. Furthermore, the fixed and/or constant distance between the at least one first enclosing shell and the at least one second enclosing shell can also be maintained irrespective of, for example, a filler, in particular a noise attenuating and/or vibration damping filler. The spacing elements can also be embodied at least partially as a single piece integral with the at least one first and/or the at least one second enclosing shell or pressure-formed together therewith.

Preferably the double-walled enclosing shell unit comprises a plurality of spacing elements, each of which is fixedly connected to the at least one first enclosing shell and to the at least one second enclosing shell, the individual spacing elements being arranged equidistantly with respect to one another, as a result of which a particularly high rigidity and low net weight of the double-walled enclosing shell unit can be achieved.

The invention furthermore relates to a medical imaging device, in particular a magnetic resonance device, having an enclosing device as claimed in one of claims 1 to 10. A particularly advantageous medical imaging device, in particular magnetic resonance device, having effective noise attenuation and/or vibration damping or vibration reduction can be provided. By this means it is furthermore possible to realize a particularly flexible enclosing device for the medical imaging device, in particular in terms of noise attenuation and/or damping of vibrations, in particular with regard to absorption of sound waves. Noise attenuating properties and/or damping properties for damping vibrations and/or sound absorption properties of the enclosing device can be influenced in particular by a choice of material for the first enclosing shell and/or a choice of material for the second enclosing shell and/or an arrangement of the two enclosing shells with respect to each other and/or other measures in relation to noise attenuation and/or noise reduction and damping of vibrations that are deemed beneficial by the person skilled in the art. Particularly advantageously, however, additional noise absorbing elements can be arranged in this case between the two enclosing shells, said elements preferably not being introduced until after assembly and installation of the enclosing device in order in that way to allow easy assembly and installation with a lightweight enclosing device. Furthermore, a selection of the noise absorbing elements can be adapted to match an anticipated radiation of noise from the medical imaging device, in particular the magnetic resonance device.

### BRIEF DESCRIPTION OF THE DRAWINGS

Further advantages, features and details of the invention will become apparent from the exemplary embodiment described hereinbelow as well as with reference to the drawings, in which:

FIG. 1 shows a medical imaging device in a schematic view, and

FIG. 2 shows a section through an enclosing device of the medical imaging device.

### DETAILED DESCRIPTION OF INVENTION

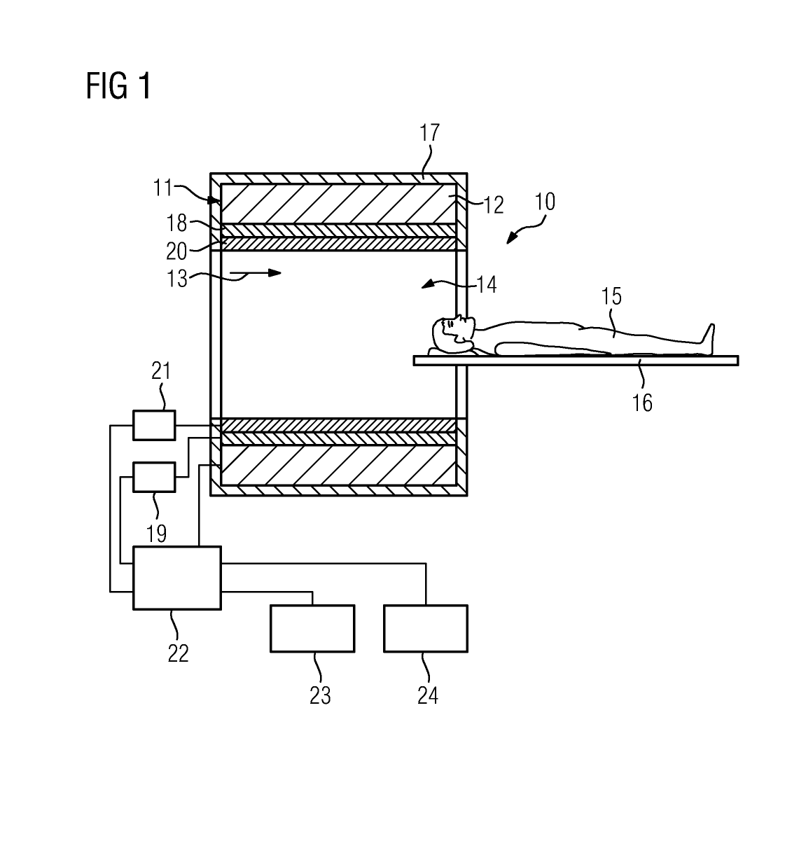

FIG. 1 shows a schematic view of an inventive medical imaging device that is formed by a magnetic resonance device 10. Furthermore, the medical imaging device can also be formed by an imaging device comprising a magnetic resonance device 10, such as an MR-PET device for example.

The magnetic resonance device 10 comprises a magnet unit 11 having a main magnet 12 for generating a strong and in particular constant main magnetic field 13. The magnetic resonance device 10 also has a cylinder-shaped receiving area 14 for accommodating a patient 15, the receiving area 14 being enclosed by the magnet unit 11 in a circumferential direction. The patient 15 can be introduced into the receiving area 14 by means of a patient couch 16 of the magnetic resonance device 10. For this purpose the patient couch 16 is arranged so as to be movable within the magnetic resonance device 10. In addition the magnetic resonance device 10 has a housing unit 17 surrounding the magnet unit 11.

The magnet unit 11 additionally has a gradient coil unit 18 for generating magnetic field gradients which is used for spatial encoding during an imaging session. The gradient coil unit 18 is controlled by means of a gradient control unit 19. The magnet unit 11 also has a radio-frequency antenna unit 20 and a radio-frequency antenna control unit 21 for stimulating a polarization which becomes established in the main magnetic field 13 generated by the main magnet 12. The radio-frequency antenna unit 20 is controlled by the radio-frequency antenna control unit 21 and radiates radio-frequency magnetic resonance sequences into an examination space which is formed substantially by the receiving area 14.

For the purpose of controlling the main magnet 11, the gradient control unit 19 and the radio-frequency antenna control unit 21, the magnetic resonance device 10 has a control unit 22 formed by a computing unit 22. The control unit 22 is used for central control of the magnetic resonance device 10, such as performing a predetermined imaging gradient echo sequence for example. Control information such as imaging parameters, for example, as well as reconstructed magnetic resonance images can be displayed on a display unit 23, for example on at least one monitor, of the magnetic resonance device 10 for viewing by an operator. Furthermore, the magnetic resonance device 10 has an input unit 24 by means of which information and/or parameters can be entered by an operator during a measurement procedure.

The magnetic resonance device 10 shown can obviously comprise further components that magnetic resonance devices 10 typically include. Furthermore, the general mode of operation of a magnetic resonance device 10 is known to the person skilled in the art, so a detailed description of the general components will be dispensed with.

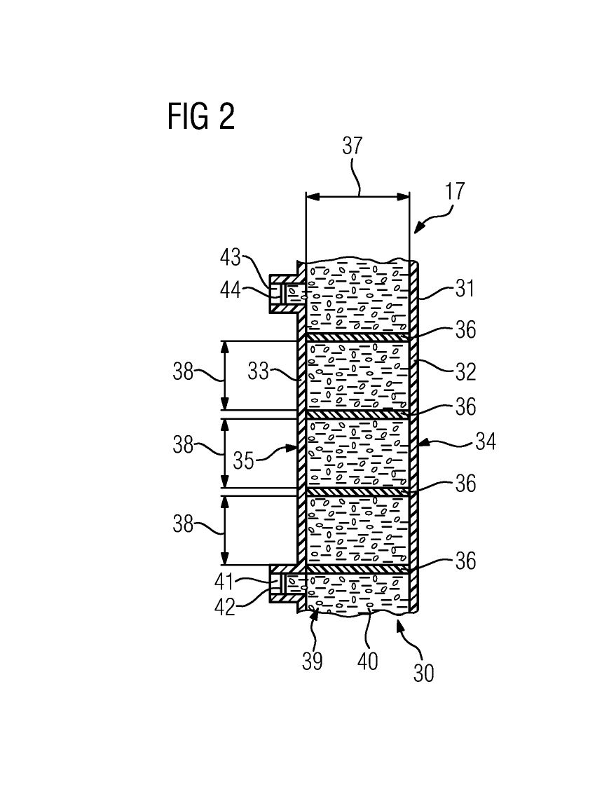

The housing unit 17 is illustrated in greater detail in FIG. 2 and comprises an enclosing device 30 having a double-walled enclosing shell unit 31. For this purpose the enclosing device 30 comprises a plurality of first enclosing shells 32 and a plurality of second enclosing shells 33, only one first enclosing shell 32 and one second enclosing shell 33 being shown in each case in FIG. 2 by way of example. The first enclosing shells 32 are assembled to form an inner enclosing shell unit 34 and the second enclosing shells 33 are assembled to form an outer enclosing shell unit 35.

The individual first enclosing shells 32 and the individual second enclosing shells 33 are preferably formed by a deep-drawn thermoplastic. Basically, however, a different embodiment of the first enclosing shells 32 and/or the second enclosing shells 33 therefrom is also possible at any time.

The inner enclosing unit 34 and the outer enclosing unit 35 are arranged spaced at a distance from each other. The inner enclosing shell unit 34 and the outer enclosing shell unit 35 are pressed together at edges (which are not shown in further detail) to form the double-walled enclosing shell unit 31, such as by means of a twin-sheet process for example. In order to attain a sufficiently high degree of rigidity for the enclosing device 30, the double-walled enclosing shell unit 31 has spacing elements 36 which are arranged between the first enclosing shells 32 and the second enclosing shells 33 or, as the case may be, the inner enclosing shell unit 34 and the outer enclosing shell unit 35. In this arrangement the individual spacing elements 36 are fixedly connected to the first enclosing shells 32 and the second enclosing shells 33 or, as the case may be, to the inner enclosing shell unit 34 and the outer enclosing shell unit 35.

The individual spacing elements 36 are embodied in the manner of bridging pieces, a longitudinal extension of the spacing elements 36 being aligned substantially transversely to an enclosing surface of the inner enclosing shell 34 and the outer enclosing shell 35. At end regions of the spacing elements 36 the latter are fixedly connected to the first enclosing shells 32 and the second enclosing shells 33 or are integrally embodied therewith in a single piece. A length of the spacing elements 36 corresponds in this case to a distance 37 between the first enclosing shells 32 and the second enclosing shells 33 or, as the case may be, to a distance 37 between the inner enclosing shell unit 34 and the outer enclosing shell unit 35. The individual spacing elements 36 are arranged spaced apart in relation to one another, a distance 38 between each pair of adjacent spacing elements 36 being the same in all cases.

The distance 37 between the inner enclosing shell unit 34 and the outer enclosing shell unit 35 is at least 5 mm and preferably at least 10 mm. A maximum distance 37 between the inner enclosing shell unit 34 and the outer enclosing shell unit 35 is equal to no more than 40 mm, though preferably no more than 35 mm. Particularly advantageously, however, the distance 37 between the inner enclosing shell unit 34 and the outer enclosing shell unit 35 is between 10 mm and 20 mm. The distance 37 between the inner enclosing shell unit 34 and the outer enclosing shell unit 35 can in this case be adjusted to match the magnetic resonance device 10 that is to be enclosed, the distance 37 moreover being chosen with regard to realizing a maximally compact and rigid enclosing shell unit 31.

The inner enclosing shell unit 34 and outer enclosing shell unit 35, when brought together by pressure forming, enclose a receiving chamber 39 of the double-walled enclosing shell unit 31. The receiving chamber 39 has a width corresponding to the distance 37 between the inner enclosing shell unit 34 and the outer enclosing shell unit 35. The receiving chamber 39 can be filled with a filler element 40 of the double-walled enclosing shell unit 31 which, in the present exemplary embodiment, is formed by a sound absorbing filler element 40. For this purpose the double-walled enclosing shell unit 31 has at least one first opening which is formed by an inlet opening 41. The double-walled enclosing shell unit 31 additionally has a valve unit 42 which is arranged in the inlet opening 41 such that the filler element 40 can be supplied in a controlled manner.

Furthermore, the double-walled enclosing shell unit 31 has at least one second opening which is formed by an outlet opening 43. Also arranged inside said outlet opening 43 is a valve opening 44 of the double-walled enclosing shell unit 31 so that any air contained within the receiving chamber 39 can escape through the outlet opening 43 when the receiving chamber 39 is being filled with the filler element 40 by way of the inlet opening 41. The valve elements 42, 44 of the inlet opening 41 and/or outlet opening 43 can also be formed by a drain plug and/or other elements that are deemed beneficial by the person skilled in the art.

The outlet opening 43 is arranged on the double-walled enclosing shell unit 31 in such a way that the air contained within the receiving chamber 39 can escape via the outlet opening 43 when the receiving chamber 39 is being filled through the inlet opening 41 with at least one filler element 40, wherein owing to the arrangement of the outlet opening 43 on the double-walled enclosing shell unit 31 no more air can escape only when there is also no more air present inside the receiving chamber 39.

The receiving chamber 39 of the double-walled enclosing shell unit 31 is embodied to be leak-tight in terms of an exchange of gas and/or an exchange of liquids when valve elements 42, 44 of the inlet opening 41 and outlet opening 43, respectively, are closed, thereby preventing an undesirable escape of the filler element with valves 42, 44 closed. Replacement of the filler element 40 or of filler elements 40 takes place exclusively by way of the inlet opening 41 or outlet opening 43 and their associated valve elements 42, 44.

Furthermore, in an alternative embodiment of the invention, the double-walled enclosing shell unit 31 can also have more than one inlet opening 41 and also more than one outlet opening 43. Accordingly, it is also conceivable that a double-walled enclosing shell unit 31 of said type would also have a valve element 42, 44 for each opening 41, 43.

While the receiving chamber 39 is being filled, the filler element 40 is introduced into the receiving chamber 39 by way of the inlet opening 41 and the valve element 42. The filler element 40 is preferably an element having an advantageous noise attenuating and/or vibration damping and/or sound absorbing property, in particular in respect of a propagation of structure-borne sound waves. In this case the filler element 40 preferably comprises a liquid, such as water and/or oil for example, and/or a gel and/or a gas and/or a granulate, etc. Furthermore it is also possible for the interior of the receiving chamber 39 to be filled with two or more different filler elements 40.

The present enclosing device 30 is characterized by a high degree of rigidity. In an unfilled state the enclosing device 30 furthermore has a particularly low weight, which means that the enclosing device 30 is particularly easy to handle during transportation and/or during assembly and installation and/or during maintenance and/or service activities. By means of the openings 41, 43 and the valve elements 42, 44 it is possible to fill the enclosing device 30, in particular the double-walled enclosing shell unit 31, with one or more filler elements 40, in particular with sound absorbing filler elements 40.

In order to fill the receiving chamber 39, the filler element 40 is introduced through the open inlet opening 41 and the open valve element 42 arranged therein, the outlet opening 43 with the valve element 44 arranged therein simultaneously being opened in order to allow the air contained within the receiving chamber 39 to escape. As soon as the receiving chamber 39 has been filled and no more air escapes through the outlet opening 43, the valve elements 44 are closed.

In the filled state of the receiving chamber 39, the enclosing device 30 exhibits advantageous noise attenuation and/or sound absorption properties, thus reducing the propagation of sound waves, in particular structure-borne sound waves, through the double-walled enclosing shell unit 31.

The housing unit 17 is at least partially dismantled in order to allow maintenance work and/or service activities to be carried out on the magnetic resonance device 10. For this purpose the filler element 40 or filler elements 40 are first removed from the receiving chamber 39 by opening the two valve elements 42, 44 of the inlet opening 41 and the outlet opening 43. The filler element 40 or filler elements 40 can escape through the inlet opening 41 and air can flow into the receiving chamber 39 again through the outlet opening 43 in order to avoid a negative pressure inside the receiving chamber 39. In the empty state the double-walled enclosing shell unit 31 has a particularly low weight and can be removed particularly easily from the magnet unit 11.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the term “comprising” does not exclude other elements or steps and the use of articles “a” or “an” does not exclude a plurality.

1. An enclosing device for a magnetic resonance device, comprising:
a double-walled enclosing shell unit which comprises a first enclosing shell and a second enclosing shell.

2. The enclosing device as claimed in claim 1,
wherein the double-walled enclosing shell unit includes a receiving chamber which is arranged between the first enclosing shell and the second enclosing shell.

3. The enclosing device as claimed in claim 2,
wherein the receiving chamber is embodied as leak-tight in respect of an exchange of gas and/or an exchange of liquid.

4. The enclosing device as claimed in claim 2,
wherein the double-walled enclosing shell unit includes a filler element arranged inside the receiving chamber.

5. The enclosing device as claimed in claim 4,
wherein the filler element comprises at least one element selected from the group consisting of a liquid, a gel, a granulate, and a gas.

6. The enclosing device as claimed in claim 1,
wherein the double-walled enclosing shell unit includes an inlet opening with a valve element.

7. The enclosing device as claimed in claim 1,
wherein the double-walled enclosing shell unit includes an outlet opening with a valve element.

8. The enclosing device as claimed in claim 1,
wherein the first enclosing shell is arranged at a distance of at least 5 mm from the second enclosing shell.

9. The enclosing device as claimed in claim 1, wherein the double-walled enclosing shell unit includes a spacing element arranged between the first enclosing shell and the second enclosing shell.

10. The enclosing device as claimed in claim 9,
wherein the spacing element is fixedly connected to the first enclosing shell and/or to the second enclosing shell.

11. A magnetic resonance imaging device, comprising:
an enclosing device, comprising:
a double-walled enclosing shell unit which comprises a first enclosing shell and a second enclosing shell.

12. The magnetic resonance imaging device as claimed in claim 11,
wherein the double-walled enclosing shell unit includes a receiving chamber which is arranged between the first enclosing shell and the second enclosing shell.

13. The magnetic resonance imaging device as claimed in claim 12,
wherein the receiving chamber is embodied as leak-tight in respect of an exchange of gas and/or an exchange of liquid.

14. The magnetic resonance imaging device as claimed in claim 12,
wherein the double-walled enclosing shell unit includes a filler element arranged inside the receiving chamber.

15. The magnetic resonance imaging device as claimed in claim 14,
wherein the filler element comprises at least one element selected from the group consisting of a liquid, a gel, a granulate, and a gas.

16. The magnetic resonance imaging device as claimed in claim 11,
wherein the double-walled enclosing shell unit includes an inlet opening with a valve element.

17. The magnetic resonance imaging device as claimed in claim 11,
wherein the double-walled enclosing shell unit includes an outlet opening with a valve element.

18. The magnetic resonance imaging device as claimed in claim 1,
wherein the first enclosing shell is arranged at a distance of at least 5 mm from the second enclosing shell.

19. The magnetic resonance imaging device as claimed in claim 1,
wherein the double-walled enclosing shell unit includes a spacing element arranged between the first enclosing shell and the second enclosing shell.

20. The magnetic resonance imaging device as claimed in claim 9,
wherein the spacing element is fixedly connected to the first enclosing shell and/or to the second enclosing shell.
